(19) United States
(12) Patent Application Publication
(10) Pub. No.: US 2023/0048786 A1
(43) Pub. Date: Feb. 16, 2023

(54) COIL LAYOUT FOR A GENERATOR HAVING TAPE CONDUCTORS

(71) Applicant: Siemens Gamesa Renewable Energy A/S, Brande (DK)

(72) Inventors: Shaoshen Xue, Dronfield (GB); Arwyn Thomas, Breaston (GB)

(21) Appl. No.: 17/795,265

(22) PCT Filed: Dec. 23, 2020
(86) PCT No.: PCT/EP2020/087747

§ 371 Date: Jul. 26, 2022

(30) Foreign Application Priority Data
Jan. 28, 2020 (EP) 20154030.9

(51) Int. Cl. H02K 55/04; H02K 7/18

(52) U.S. Cl. CPC H02K 55/04; H02K 7/1838; F03D 9/25

(57) ABSTRACT

An electric generator has a stator, a rotor and a coil on the stator or the rotor. The coil includes a plurality of turns of one or more high-temperature superconducting conductors shaped as a tape. Each tape conductor includes a substrate having a flat section and a high-temperature superconducting layer, the high-temperature superconducting layer being laid over one of the two major sides of the substrate, the high-temperature superconducting layer having a width in a direction parallel to the major side of the substrate. The turns of the coil are stacked in such a way that the major sides of the substrate are superposed to one another to form a coil section having a first dimension parallel to the width of the high-temperature superconducting layer and a second dimension orthogonal to the first dimension, the ratio between the first dimension and the second dimension being between 2 and 5.

### CROSS-REFERENCE TO RELATED APPLICATIONS

This application claims priority to PCT Application No. PCT/EP2020/087747, having a filing date of Dec. 23, 2020, which claims priority to EP Application No. 20154030.9, having a filing date of Jan. 28, 2020, the entire contents both of which are hereby incorporated by reference.

### FIELD OF TECHNOLOGY

The following relates to a coil layout for an electric generator having tape conductors, in particular a high-temperature superconducting (HTS) generator. The present invention further relates to a method of providing a coil layout in an electric generator having tape conductors, in particular in a high-temperature superconducting (HTS) generator. Particularly, but not exclusively, the following may be applied to a HTS generator in a wind turbine.

### BACKGROUND

In the above-described technical field, it is known to use superconducting electric generators for wind turbines. The use of superconductors in wind turbines is attractive because it permits to reduce weight or to generate a larger amount of power. High-temperature superconducting (HTS) generators may be conveniently used in wind turbine applications, as they are characterized by a higher critical temperature for superconductivity (77K or lower).

In electrical generators a coil geometry having superposed turns of one or more conductors in the shape of a tape may be required. In superconducting electrical machines, higher flux density on the high-temperature superconductors in the direction orthogonal to major side of the tape section (c-axis direction) results in lower critical current and then lower torque. To reduce the c-axis flux density on the superconductors, flux diverters may be installed next to the superconductors to attract flux from the superconductors.

There may be therefore still a need for providing a superconducting electric generator including a coil geometry, which allows significantly reducing the flux density perpendicular to the superconductors tape sections, without any other additional construction of the electrical machine.

### SUMMARY

An aspect relates to an electric generator. The electric generator has a stator, a rotor and a coil on the stator or on the rotor. The coil includes a plurality of turns of one or more high-temperature superconducting conductors shaped as a tape, each tape conductor including a substrate having a flat section and a high-temperature superconducting layer, the high-temperature superconducting layer being laid over one of the two major sides of the substrate, the high-temperature superconducting layer having a width in a direction parallel to the major side of the substrate. The turns of the coil are stacked in such a way that the major sides of the substrate are superposed to one another to form a coil section having a first dimension parallel to the width of the high-temperature superconducting layer and a second dimension orthogonal to the first dimension, the ratio between the first dimension and the second dimension being comprised between 2 and 5.

Embodiments of the invention can be efficiently adapted to a superconducting electric generator of a wind turbine.

According to a second aspect of embodiments of the invention there is provided a method of providing a coil in a stator or a rotor of an electric generator. The method includes the step of providing a plurality of turns on the stator or the rotor of one or more high-temperature superconducting conductors shaped as a tape, each tape conductor including a substrate having a flat section and a high-temperature superconducting layer, the high-temperature superconducting layer being laid over one of the two major sides of the substrate, the high-temperature superconducting layer having a width in a direction parallel to the major side of the substrate, the turns of the coil being stacked in such a way that the major sides of the substrate are superposed to one another to form a coil section having a first dimension parallel to the width of the high-temperature superconducting layer and a second dimension orthogonal to the first dimension, the ratio between the first dimension and the second dimension being comprised between 2 and 5.

The coil geometry provided by embodiments of the present invention allows significantly reducing the flux density perpendicular to the superconductors tape sections, without any other additional construction of the electrical machine

According to possible embodiments of the present invention, the turns of the coil are stacked along the direction axis of the flux density of the current flowing in high-temperature superconducting conductors.

According to other possible embodiments of the present invention, the width of the high-temperature superconducting layer is comprised between 4.3 mm and 13 mm.

According to further possible embodiments of the present invention, the coil includes a plurality of N turns of one or more high-temperature superconducting conductors shaped as a tape, N being comprised between 20 and 60.

All the above-described embodiments apply to both the apparatus and the method of embodiments of the present invention.

The aspects defined above, and further aspects of the present invention are apparent from the examples of embodiment to be described hereinafter and are explained with reference to the examples of embodiment. The following will be described in more detail hereinafter with reference to examples of embodiment but to which the invention is not limited.

### BRIEF DESCRIPTION

Some of the embodiments will be described in detail, with reference to the following figures, wherein like designations denote like members, wherein:

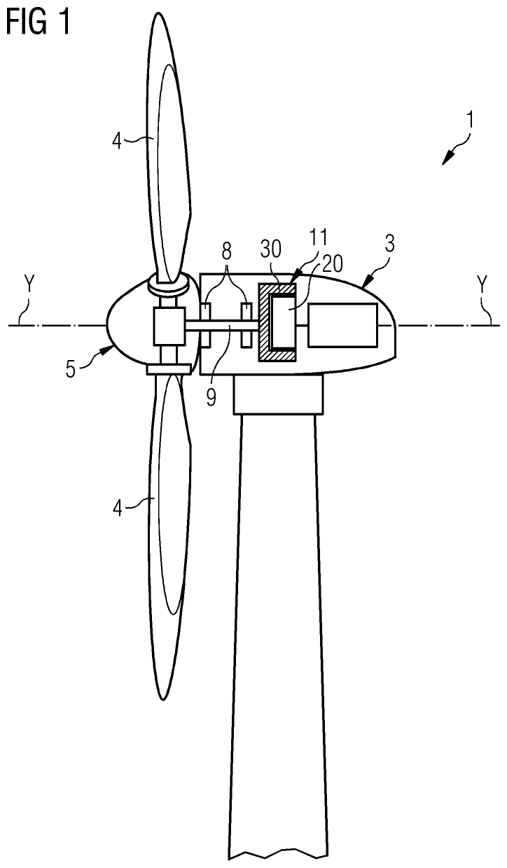

FIG. 1 shows a schematic section of a wind turbine including an electric generator;

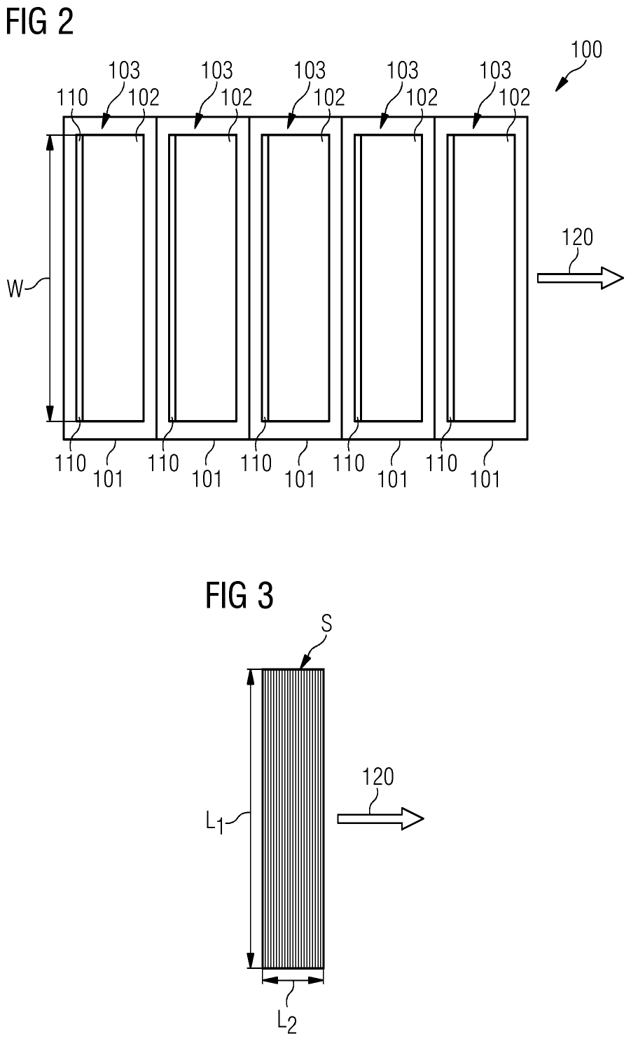

FIG. 2 shows a schematic partial cross section view of a coil geometry provided on the stator or the rotor of FIG. 1, the coil including a plurality of turns configured according to embodiments of the present invention;

FIG. 3 shows a schematic cross section view of a coil geometry provided on the stator or the rotor of FIG. 1, the coil including a plurality of turns configured according to embodiments of the present invention; and

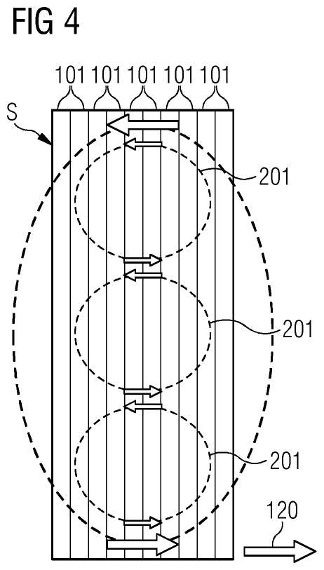

FIG. 4 shows a schematic representation of the critical current and the critical torque T in the section of FIG. 3.

### DETAILED DESCRIPTION

FIG. 1 shows a wind turbine 1 according to embodiments of the invention. The wind turbine 1 comprises a tower 2, which is mounted on a non-depicted fundament. A nacelle 3 is arranged on top of the tower 2. The wind turbine 1 further comprises a wind rotor 5 having two, three or more blades 4 (in the perspective of FIG. 1 only two blades 4 are visible). The wind rotor 5 is rotatable around a rotational longitudinal axis Y. When not differently specified, the terms axial, radial and circumferential in the following are made with reference to the rotational axis Y. The blades 4 extend radially with respect to the rotational axis Y. The wind turbine 1 comprises a permanent magnet electric generator 11.

According to other possible embodiments of the present invention (not represented in the attached figures), embodiments of the present invention may be applied to any other type of permanent magnet machine with either internal or external rotor. The wind rotor 5 is rotationally coupled with the permanent magnet generator 11 either directly, e.g., direct drive or by a rotatable main shaft 9 and through a gear box (not shown in FIG. 1). A schematically depicted bearing assembly 8 is provided in order to hold in place the main shaft 9 and the rotor 5. The rotatable main shaft 9 extends along the rotational axis Y. The permanent magnet electric generator 10 includes a stator 20 and a rotor 30. The rotor 30 is rotatable with respect to the stator 20 about the rotational axis Y. The stator 20 and/or the rotor 30 may have a toothed structure. On the stator 20 and/or on the rotor 30 a coil including one or more high-temperature superconducting (HTS) conductors is provided according to embodiments of the present invention and configured as described in the following.

FIG. 2 shows a geometry of a coil 100 including one or more high-temperature superconducting (HTS) tapes 101. The tape 101 includes a substrate 102 having a flat rectangular section and a high-temperature superconducting layer 110, which is laid over one of the two major sides of the substrate 102. The high-temperature superconducting layer 110 has a width W, in a direction parallel to the major side of the substrate 102. According to embodiments of the present invention, W may be comprised between 4.3 and 13 mm. The tape 101 further includes a copper coating 103 surrounding the assembly made of the substrate 102 and the high-temperature superconducting layer 110. The critical current of the HTS tape is determined by the flux density on the perpendicular direction of the high-temperature superconducting layer 110, which is also the direction perpendicular to the two major sides of the substrate 102. This direction is defined as the c-axis 120 of the HTS tape 101. In the coil 100 geometry the HTS tape(s) 101 is(are) usually stacked alongside the c-axis 120. In other words, the turns in the coil 100 geometry (five turns are shown in the coil geometry 100 of FIG. 2) are stacked in such a way that the major sides of the substrate(s) 102 are superposed to one another. In the section view of FIG. 2, the high-temperature superconducting layers 110 are arranged in alternating disposition with the substrates 102.

According to other embodiments of the present invention (not shown), the width W of the coil may be made up of a plurality of tapes 101 connected in parallel or series, each of the tape being narrower than W, so that the coil width ratio is not limited to the maximum dimensions of the tapes. If the tapes are connected in parallel, then they can be arranged to minimize current imbalance between parallel strands in a stator slot, according to well-known techniques for a person skilled in the art of electrical machine design.

FIG. 3 shows an embodiment of the coil 100 having a section S obtained by stacking a plurality of N turns of one or more high-temperature superconducting (HTS) tapes 101, as described in FIG. 2. According to embodiments of the present invention, N may be comprised between 20 and 60. The section S is rectangular is shape, having a first dimension L1 perpendicular to the c-axis 120 and a second dimension L2 parallel to the c-axis 120. The first dimension L1 is greater than the second dimension L2. The ratio R=L1\L2 between the first dimension L1 and the second dimension L2 is comprised between 2 and 5.

FIG. 4 shows the critical current J in the section S and the critical torque T generated by the critical current J. The critical current J is schematically represented by a plurality of closed current paths 201 (three closed paths 201 are shown in FIG. 4) distributed along the direction orthogonal to the c-axis 120, i.e., along the first dimension L1 of the section S. The critical torque T is schematically represented by a closed torque path 301, being the envelope of the plurality of current paths 201. As shown in FIG. 4, at areas of the section S where two current paths 201 are adjacent a flux cancellation is achieved, because in such areas the fluxes deriving from the two adjacent current paths 201 are of equal magnitude and opposite direction. This permits to achieve higher critical currents with respect to coil sections having other aspect ratio, in particular with respect to coil sections where the second dimension L2 parallel to the c-axis 120 is greater than the first dimension L1 orthogonal to the c-axis 120. Critical current and torque can be significantly improved with a section S having an aspect ratio which is wider along the tape width W.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. An electric generator having a stator, a rotor and a coil on the stator or on the rotor, the coil including a plurality of turns of one or more high-temperature superconducting conductors shaped as a tape, each tape conductor including a substrate having a flat section and a high-temperature superconducting layer, the high-temperature superconducting layer being laid over one of the two major sides of the substrate, the high-temperature superconducting layer having a width in a direction parallel to the major side of the substrate, the turns of the coil being stacked in such a way that the major sides of the substrate are superposed to one another to form a coil section having a first dimension parallel to the width of the high-temperature superconducting layer and a second dimension orthogonal to the first dimension, the ratio between the first dimension and the second dimension being between 2 and 5.

2. The electric generator of claim 1, wherein the turns of the coil are stacked along the direction axis of the flux density of the current flowing in high-temperature superconducting conductors.

3. The electric generator of claim 1, wherein the width of the high-temperature superconducting layer is between 4.3 mm and 13 mm.

4. The electric generator of claim 1, wherein the coil includes a plurality of N turns of one or more high-temperature superconducting conductors shaped as a tape, N being between 20 and 60.

5. The electric generator of claim 1, wherein the high-temperature superconducting conductors includes a copper coating surrounding the assembly made of the substrate and the high-temperature superconducting layer.

6. The electric generator of claim 1, wherein the width of the high-temperature superconducting layer is made up of a in a direction parallel to the major side of the substrate is made up of one tape conductor.

7. The electric generator of claim 1, wherein the width of the high-temperature superconducting layer in a direction parallel to the major side of the substrate is made up of a plurality of tape conductors connected in parallel or series.

8. A method of providing a coil in a stator or a rotor of an electric generator, the method including the step of providing a plurality of turns on the stator or the rotor of one or more high-temperature superconducting conductors shaped as a tape, each tape conductor including a substrate having a flat section and a high-temperature superconducting layer, the high-temperature superconducting layer being laid over one of the two major sides of the substrate, the high-temperature superconducting layer having a width in a direction parallel to the major side of the substrate, the turns of the coil being stacked in such a way that the major sides of the substrate are superposed to one another to form a coil section having a first dimension parallel to the width of the high-temperature superconducting layer and a second dimension orthogonal to the first dimension, the ratio between the first dimension and the second dimension being between 2 and 5.
